(19) United States
(12) Patent Application Publication
(10) Pub. No.: US 2026/0258250 A1
(43) Pub. Date: Sep. 3, 2026

(54) Insoluble product, in particular coloring agent, and method for the production thereof

(71) Applicant: Döhler GmbH, Darmstadt (DE)

(72) Inventors: Roland BECK, Darmstadt (DE); Willi MOOR, Pfungstadt (DE)

(73) Assignee: Döhler GmbH, Darmstadt (DE)

(21) Appl. No.: 18/995,746

(22) PCT Filed: Aug. 30, 2023
(86) PCT No.: PCT/EP2023/073828

§ 371 Date: Jan. 16, 2025

(30) Foreign Application Priority Data
Sep. 1, 2022 (DE) 10 2022 003 190.6

(51) Int. Cl. C09B 67/42; C09B 61/00; C09B 67/04; C09B 67/06

(52) U.S. Cl. CPC C09B 67/0094; C09B 61/00; C09B 67/0002; C09B 67/0003

(57) ABSTRACT

A colorant (1) includes at least one pigment (10) which includes at least one water-swellable, hydrophilic but water-insoluble polysaccharide (2) and at least one dye (3). The disclosure also relates to a method for producing such a colorant (1).

### CROSS-REFERENCE TO RELATED APPLICATION

This application is a national stage application, filed under 35 U.S.C. § 371, of International Patent Application PCT/EP2023/073828, filed on Aug. 30, 2023, which claims the benefit of German Patent Application DE 10 2022 003 190.6, filed on Sep. 1, 2022.

### TECHNICAL FIELD

The invention relates to an insoluble product, in particular a colorant, and to a method for its preparation, as well as to the use of beta-1,4-mannans, in particular from the tagua nut, for producing such products as colorants, preferably for producing an insoluble colorant that includes at least one soluble dye. The colorant can preferably be used as wall paints, artist paints or other paints or lacquers known to a person skilled in the art, and also for coloring foodstuff, luxury food, dietary supplements, cosmetic or pharmaceutical products.

### BACKGROUND

Colorants can be divided into two groups, firstly soluble dyes and secondly insoluble dyes. Insoluble dyes are also referred to as pigment dyes or pigments. The physical and chemical properties of these two groups differ in their interaction with light. The color impression of soluble dyes is created by absorption of light of the corresponding wavelength. Pigment dyes are based on the reflection and scattering of light on the pigment particles.

The conversion of soluble into insoluble dyes is referred to as laking. In this process, a soluble dye is bound to an aluminum hydroxide gel via ionic interaction, often with the addition of multivalent cations such as Ca⁺⁺ or Mg⁺⁺. Well-known examples of such aluminum lakes, which are used in the food and cosmetic sectors, are genuine carmine (E120, CI Natural Red 4) or lake colors of artificial food colorants such as tartrazine (E102, CI Food Yellow 4), quinoline yellow (E104, CI Food Yellow 13), yellow-orange S (E110, CI Food Yellow 3), Allura red (E129, CI Food Red 17), Ponceau 4R (E124, Cochineal red A, CI Food Red 7), Carmoisine (E122, Azorubine, CI Food Red 3), Brilliant blue FCF (E133, CI Food Blue 2), Patent blue (E131, CI Food Blue 5), just to name the most common.

Although aluminum lakes of the natural dyes curcumin, carmine, copper complexes of chlorophylls and chlorophyllins, and anthocyanins are in principle permitted as food additives in the EU (EU Regulation 1333/208), they can no longer be used for the most part due to their aluminum content as a result of an amendment (EU Regulation 380/2012), as the legally specified maximum values would be exceeded with common usage quantities. In the USA, only the aluminum lakes of the approved artificial food dyes are permitted; aluminum lakes of natural food dyes are not permitted.

In contrast to lake colors made from artificial dyes, the laking of natural dyes often results in a change in color. For example, the red anthocyanins become more or less blue anthocyanin lakes, and the orange carminic acid becomes a red-violet carmine lake. The associated change in absorption in the longer wavelength range of the visible light spectrum is explained in the literature by complex formation of the dyes with the aluminum cation. This color shift naturally occurs in red or blue flowering hydrangeas, caused by the complexation of the flower anthocyanins with aluminum.

### SUMMARY

Since, on the one hand, the production of such aluminum lakes is associated with color shifts and, on the other hand, the field of application of such aluminum lakes is severely limited due to the high aluminum content and consumers demand more natural, pigmentary dyes, for example in the cosmetics sector, the object of the present invention is to find a new colorant or a new way of converting soluble into insoluble colorants, which does not exhibit the aforementioned problems.

This object is achieved by a colorant that comprises at least one pigment which includes at least one water-swellable, hydrophilic but water-insoluble polysaccharide, and at least one dye.

The term “colorant” refers to the composition according to the invention having a color that is visually perceptible to humans. The term “pigment” refers to an insoluble colorant. This pigment includes a dye which per se is soluble in a solvent, and at least one water-swellable, hydrophilic but water-insoluble polysaccharide, in particular at least one beta-1,4-mannan.

In the context of the invention, it has surprisingly been found that a matrix encapsulation of such a dye in polysaccharide, in particular in beta-1,4-mannans, converts a soluble dye into an insoluble formulation and thus enables a color effect due to reflection and scattering on the particles of the pigment rather than due to absorption in the solution of the dye. It has also been found that this effect is likewise suitable for other substances in addition to soluble dyes, for converting them into an insoluble state and thus, so to speak, laking them. Most polysaccharides are either hydrophilic and water-soluble, such as inulin, maltodextrin, xanthan gum, pectin, gum arabic, gum ghatti, guar or locust bean gum, or else water-insoluble, such as cellulose or most hemicelluloses, or else water-soluble but have a hydrophobic internal surface, such as starch, amylose, or amylopectin, which is not suitable for the encapsulation of hydrophilic dyes.

Surprisingly, it has been found that a water-swellable, hydrophilic but water-insoluble polysaccharide which includes at least one beta-1,4-mannan and preferably consists essentially of beta-1,4-mannans and in particular was obtained from the endosperm of the tagua nut fruit, can serve very well as a matrix for encapsulating soluble dyes. The endosperm of the tagua nut itself is often referred to as “tagua nut”, since the dried endosperm is very hard and was historically used as a material for buttons, for example.

The main component of the tagua nut polysaccharides are mannans, which have the desired properties. The statement “consists essentially of beta-1,4-mannans” refers to the fact that the carrier substance according to the invention for the dyes may also contain other mannans or polysaccharides in addition to the beta-1,4-mannans when using a natural source such as the tagua nut, due to the biological origin in the plant in question.

Synthetically produced beta-1,4-mannans can also be used for the matrix encapsulation of the dyes within the scope of the invention.

It has been observed that the matrix encapsulation with tagua nut polysaccharides improves the stability of the encapsulated dyes against oxidation or hydrolysis.

A decisive advantage over commercially available lake colors is the fact that no metal salts are used for the process of “rendering insoluble” using beta-1,4-mannans and especially tagua nut polysaccharides, thereby completely avoiding a chemical reaction therewith, which could lead to a change in color. The color shades will therefore remain unchanged, which has been a previously unsolved problem, especially when it comes to the laking of anthocyanins.

The colorant according to the invention, preferably the pigment contained in this colorant, is provided in the form of a powder, with a particle size D_{90.3} in particular in the range of up to about 120 μm, preferably up to 100 μm, more preferably from about 0.5 μm to about 50 μm, yet more preferably from about 1 μm to about 20 μm, and most preferably of about 15 μm.

Within the scope of the invention, the colorant may also contain one or more further components and/or auxiliary substances, which are preferably selected from the group comprising vitamins, bioactive ingredients and active substances, pharmaceutical active substances and fillers, as well as mixtures of at least two of the aforementioned components and/or additives.

It will be appreciated that the invention is not only applicable to soluble dyes. Rather, the invention provides an insoluble product which comprises at least one beta-1,4-mannan which is preferably obtained from the endosperm of the tagua nut, and includes at least one soluble substance which is selected from the group comprising dyes, flavors, pharmaceutical active ingredients, antioxidants, cosmetic active ingredients, dietary supplements, and mixtures of at least two of the substances mentioned. In particular, the invention provides a colored product, preferably wall paint, artist paint, craftsman's paint or lacquer, foodstuff, luxury food, dietary supplement, cosmetic or pharmaceutical product, comprising a colorant as described above.

The particle size distributions were measured by laser light diffraction using a Malvern Mastersizer 3000 apparatus involving the detection and calculation methodology according to Mie.

The specifications on the characteristic parameters Dx are to be understood with the usual standard deviations for measurements of particle size distributions using laser light diffraction. A person skilled in the art will be able to determine the standard deviation based on multiple measurements of the colorant or pigment in question.

The most preferred, best particle size to be aimed for corresponds to a D_{90.3} value of approx. 15 μm, which means that 90% of all particles present or obtained in a particle size distribution determined by laser light diffraction have a particle size of less than 15 μm.

In the present invention, a color imparting substance that is soluble in water or in another solvent is used as the dye. The dye may be selected from the group comprising at least one natural dye, at least one synthetic dye, and/or mixtures thereof.

Of particular interest for the present invention was the conversion of soluble natural dyes, i.e. which are soluble in water or other solvents, into insoluble lake colors or dyes. “Natural dyes” in the sense of the invention are understood to be dyes of plant or animal origin. Preference is given to dyes obtained from plants (or parts of plants). Different parts of plants are preferably suitable for this purpose, depending on the desired dye. However, it will be appreciated that a dye can be obtained from more than one part of a plant. Detailed descriptions of natural dyes can be found, inter alia, in “Handbuch der Naturfarbstoffe: Vorkommen, Verwendung, Nachweis” (engl.: Handbook of Natural Dyes: Occurrence, Use, Detection), by H. Schweppe, publishing house ecomed, 1993, Landsberg/Lech, which is known to those skilled in the art.

The amount of soluble dye in the colorant according to the invention can be up to 50 wt %, based on the total weight of the colorant. Preferably, the percentage of dye is from about 0.001 to about 20 wt %, most preferably from about 0.05 to about 20 wt %.

The amount of polysaccharide in the colorant according to the invention may be up to 99.999 wt %, based on the total weight of the colorant. The minimum proportion of polysaccharide is preferably about 50 wt %. Most preferably, the amount of polysaccharide ranges from about 80 to about 99.95 wt %, based on the total weight of the colorant.

The colorant according to the invention may contain one or more further components and/or auxiliary substances, which are preferably selected from the group comprising vitamins, bioactive ingredients and/or active substances, and pharmaceutical active substances as well as mixtures of at least two of the components mentioned.

The colorant is preferably a solid, powdery solid. The colorant can then be further processed depending on the intended use. For example, it is possible to combine the colorant with one or more other components and/or auxiliary substances. The preferred components can be selected, for example, from the group comprising vitamins, bioactive ingredients and/or active substances and/or pharmaceutical active substances as well as mixtures of at least two of the components mentioned.

The invention thus makes it possible to use the colorant according to the invention for introducing at least one dye into wall paints, artist paints, craftsman's paints and lacquers or other paints and lacquers known to those skilled in the art, and also into foodstuff, a dietary supplement, cosmetic or pharmaceutical product. Since the invention is also suitable for rendering not only dyes but also other soluble substances insoluble, the invention also provides an insoluble product which comprises at least one beta-1,4-mannan, which was preferably obtained from the endosperm of the tagua nut, and includes at least one soluble substance 3 which is selected from the group comprising dyes, flavorings, pharmaceutical active ingredients, antioxidants, cosmetic active ingredients, dietary supplements, and mixtures of at least two of the substances mentioned.

The colorant or insoluble product according to the invention can be used directly. However, it can also be used in a hydrophobic form within the scope of the invention. Particularly suitable for hydrophobization are agents such as alkyl trialkoxy silanes, for example octyl triethoxy silane.

The present invention further encompasses, as a subject-matter, a method for producing the colorant according to the invention. The method for producing a colorant, preferably a colorant or pigment that is insoluble in water or other solvents, or an insoluble product as described above, comprises:
(a) providing a powder that includes at least one water-swellable, hydrophilic but water-insoluble polysaccharide;
(b) allowing the powder from step (a) to swell in an aqueous solution;
(c) bringing the mixture obtained in step (b) into contact with at least one substance selected from the group comprising dyes, flavorings, pharmaceutical active ingredients, antioxidants, cosmetic active ingredients, dietary supplements, and mixtures of at least two of the substances mentioned;
(d) separating excess liquid from the mass obtained in step (c) to obtain a solid phase (100).

The polysaccharide in step (a) may in particular be obtained from the endosperm of the tagua nut fruit. For this purpose, the dried endosperm of the tagua nut can be ground and then further used as a powder.

The polysaccharide, in particular in powder form, has a particle size D_{90.3} of up to 200 μm, preferably a particle size D_{90.3} of up to 100 μm, more preferably a particle size D_{90.3} from approx. 0.5 μm to approx. 50 μm, yet more preferably a particle size D_{90.3} from approx. 1 μm to approx. 20 μm, and most preferably a particle size D_{90.3} of approx. 15 μm. The particle size was determined as described above.

The aqueous solution in step (b) may contain at least one salt. A person skilled in the art will adjust the contents of solution and salt in such a way that the quality of swelling is optimized for the respective application case. Further possibilities for influencing the quality of the swelling are offered by the choice of salt, the temperature during swelling and its duration as well as by other parameters, for example adjusting the stirrer speed for discontinuous swelling in a stirred tank, or the energy density introduced into the suspension of powder and aqueous solution.

Preferred is salt which is appropriate for food, cosmetic and/or pharmaceutical products, whereby alkali or alkaline earth chlorides such as potassium chloride, sodium chloride, magnesium chloride, calcium chloride are preferred and table salt (sodium chloride) is particularly preferred. The at least one salt may also be a mixture of at least two of the chlorides mentioned. The preferred amount of salt ranges from about 1 to about 40 wt %, preferably about 10 to 25 wt %, most preferably 20 wt %, based on the total weight of the aqueous solution. The optimum duration of swelling is from about 30 minutes to 24 hours, preferably 45 minutes to 12 hours, most preferably 1 to 2 hours. The optimum temperature in step (b) is between about 15 and about 40° C., preferably about 18° C. to 30° C., most preferably about 20 to about 25° C.

The “bringing into contact” in step (c) can be accomplished using any technique suitable for this purpose and known to those skilled in the art, preferably by mixing. During step (c), matrix encapsulation occurs. The dye as the active component—or another soluble substance, more details of which will be discussed below—is homogeneously mixed with the polysaccharide as the enveloping component or “matrix” which includes at least one beta-1,4 mannan and preferably consists essentially of beta-1,4 mannans. This produces a mixture in which the active component is evenly distributed in the matrix.

In the present invention, a color imparting substance that is soluble in water or in another solvent is used as the dye. The dye can be selected from the group comprising at least one natural dye, at least one synthetic dye, and/or mixtures thereof. Thus, in the context of the invention, the at least one dye is selected from the group that includes natural dyes and/or synthetic dyes that are soluble in water or in other solvents as well as mixtures of at least two of such natural dyes and/or synthetic dyes. Natural dyes are preferred. The soluble dyes used in the method according to the invention may come in the form of a plant extract.

The separation (d) may be accomplished using any technique suitable for this purpose and known to those skilled in the art, preferably by filtration, centrifugation or drying. The separation of the solid phase from the liquid phase results in obtaining a separated solid phase which includes the target product—the colorant.

In an advantageous refinement of the invention, the method comprises the further step:
(d1) drying the mass obtained in step (c) and/or the solid phase obtained in step (d).

It is particularly advantageous if the separation in step (d), preferably carried out by filtration or centrifugation, is supported by a drying process (d1).

In a simple embodiment, the separated solid phase, for example in the form of a filter cake, may be flowed through by an air stream, in particular at a pressure in the range of up to and including 5 bar, preferably at a pressure of 2 bar, directed towards the filter layer. An inert gas can also be used instead of compressed air. For the drying step (d1) it is preferred that the product temperature reaches not more than approx. 70° C. and preferably ranges from approx. 55° C. to approx. 68° C.; it is particularly preferred that the product temperature does not exceed a temperature of 65° C. The term “product temperature” refers to the temperature of the material to be dried.

In an advantageous refinement of the invention, the method comprises the further step:
(e) comminuting the particularly dried target product, i.e. the solid phase, from step (d), to obtain a powder which has a particle size D_{90.3} of up to 100 μm, preferably from about 0.5 μm to about 50 μm, more preferably from about 1 μm to about 20 μm, most preferably of about 15 μm.

The particle size can be measured as described above.

In a further refinement of the method described above, it may comprise a further step, namely the step
(f) introducing
   the mixture of swollen polysaccharide in aqueous solution and at least one dye as obtained in step (c); and/or
   the solid phase as separated in step (d); and/or
   the solid phase dried in step (d1); and/or
   the dried solid phase comminuted in step (e)
   into a product which is particularly selected from the group comprising wall paints, artist paints, craftsman's paints and lacquers, foodstuff, luxury food, dietary supplements, cosmetic and pharmaceutical products. In this way, a colored product can be produced.

The method according to the invention can also be used to convert other soluble substances, not just dyes, into their insoluble form. An encapsulation according to the invention can in particular protect the enclosed substance against oxidation. Encapsulation also makes it possible to convert a liquid or paste into a solid dosage form and to stabilize it against other substances present in the final formulation (food, cosmetic or pharmaceutical product). The substance can then be selected in its insoluble form depending on the intended use. Thus, a further subject-matter of the invention is an insoluble product comprising at least one polysaccharide which includes at least one beta-1,4-mannan which is preferably obtained from the endosperm of the tagua nut fruit, and at least one soluble substance which is selected from the group comprising dyes, flavorings, pharmaceutical active ingredients, antioxidants, cosmetic active ingredients, dietary supplements, and mixtures of at least two of the substances mentioned.

In addition, the present invention also encompasses the use of at least one polysaccharide which preferably comprises at least one beta-1,4-mannan and particularly preferably consists essentially of beta-1,4-mannans and in particular has been obtained from the endosperm of the tagua nut fruit for producing an insoluble product which includes at least one substance that is soluble in water or in another solvent, which is selected in particular from the group comprising dyes, flavorings, pharmaceutical active ingredients, antioxidants, cosmetic active ingredients, dietary supplements, and mixtures of at least two of substances mentioned. It is preferred to use at least one such polysaccharide which was obtained in particular from the endosperm of the tagua nut fruit for producing an insoluble colorant that includes at least one soluble dye.

The invention shall be explained by way of the attached examples, without however being limited to the embodiments specifically described. The invention also relates to any combinations of preferred embodiments, provided that they do not exclude each other. The statements “about” or “approx.” in combination with a number mean that at least values which are higher or lower by 10% or higher or lower by 5% and in any case higher or lower by 1% shall be included. At least values higher or lower by the standard deviation resulting from at least three individual measurements of a variable shall be encompassed by specified numerical values of a variable.

### BRIEF DESCRIPTION OF THE DRAWINGS

FIG. 1 shows a schematic view of the colorant according to the invention;

FIGS. 2a, 2b and 2c show a flowchart of the method according to the invention (FIG. 2a) and optional refinements (FIGS. 2b and 2c);

FIG. 3 shows the colorants according to the invention as prepared in Examples 1 through 13 and 15; with the “ym” information on the labels corresponding to the particle size in [μm] of the colorant according to the invention;

FIG. 4 is a schematic view of a product according to the invention.

### DETAILED DESCRIPTION

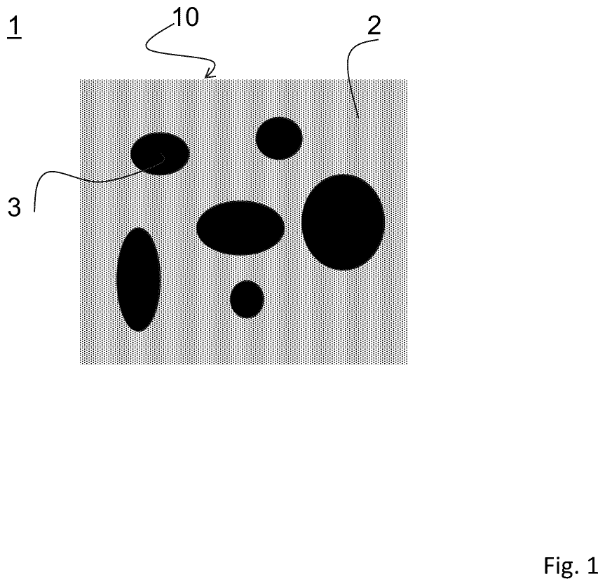

FIG. 1 shows a schematic view of the colorant 1 according to the invention. Colorant 1 comprises a pigment 10 which includes at least one water-swellable, hydrophilic but water-insoluble polysaccharide 2, and at least one dye 3. For the sake of simplicity, only one dye compartment is designated with the reference number 3 in FIG. 1. The polysaccharide 2 is in particular a polysaccharide including at least one beta-1,4-mannan. Preferably, a component consisting essentially of beta-1,4-mannans is used as the polysaccharide 2. The polysaccharide 2 may in particular be obtained from the endosperm of the tagua nut fruit.

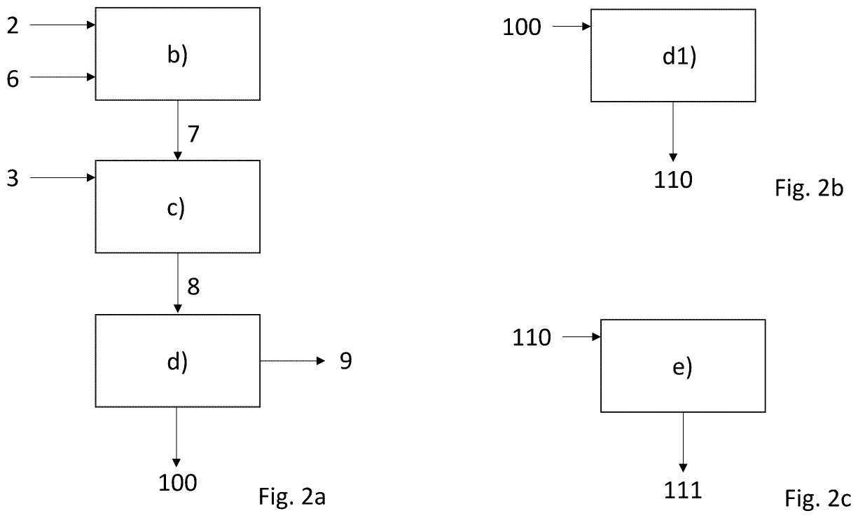

FIG. 2a shows the method according to the invention in a flow chart. In step (a), at least one water-swellable, hydrophilic but water-insoluble polysaccharide 2 is provided, in particular in the form of a powder. This is mixed with water or with an aqueous salt solution 6. In step (b), the polysaccharide swells in an aqueous solution, and a mixture 7 is formed. In step (c), the mixture 7 obtained from step (b) is brought into contact with at least one dye 3. A mass 8 is obtained. In step (d), excess liquid 9 is separated from the mass 8 obtained in step (c) to obtain the solid phase 100. Within the scope of the invention, the mass 8, the solid phase 100, or a further processed form of the solid phase 100 can be used as a colorant, depending on the application.

Within the scope of the invention it is possible to further process the solid mass 100 to meet different requirements, for example with regard to further processing, shipping, and storage. For example, the mass 100 can be dried in a step (d1) (see FIG. 2b). The dried mass 110 can be comminuted in a step (e), resulting in a powder 111. The comminution in step (e) may in particular accomplished by grinding.

### EXAMPLES

The color of the resulting colorant is described using the CIELAB color space, where the color is expressed by an L* value, an a* value, and a b* value.

The CIE LCh color space is the CIELab color space which specifies cylindrical coordinates C* (relative saturation or chroma) and h (hue angle) instead of the Cartesian coordinates a* and b*. The color lightness L* remains unchanged in this case. Common simplified notations for this color space are LCh, LCH, and HLC (hue H; lightness L; chroma C).

### Example 1: Encapsulation of Red Radish Anthocyanins in Tagua Nut Polysaccharides (Swelling in Saline Solution)

20 g of table salt are dissolved in 100 ml of hot water. 50 g of YuraQ M (tagua nut polysaccharide) having a particle size D_{90.3} of 15 μm (product of Döhler GmbH) is incorporated into this saline solution with gentle stirring and allowed to swell for 1 hour at 20° C. while stirring. 50 g of an anthocyanin extract from red radish (H95113 Cos Red Radish) with an anthocyanin content of 4.0 wt % is added and stirred until a homogeneous doughy mass is obtained (approx. 1 hour). The mass is then filtered in order to separate excess liquid. Then, the separated mass is dried in an air stream, while the product temperature does not exceed 65° C. Finally, the dried product is ground again to a particle size distribution with D_{90.3}=15 μm. The yield is 98 wt % based on the total of the masses of YuraQ M and the anthocyanin extract.

The color value of the powder is measured in a color measuring device “Digieye” (Verivide Limited, Leicester, UK) under diffuse lighting and a color temperature of 5000 K and gives the following L*a*b and C, H values:

| L | a | b | H | C |
|---|---|---|---|---|
| 25.69 | 41.09 | 8.11 | 41.88 | 11.17 |

### Example 2: Encapsulation of Red Radish Anthocyanins in Tagua Nut Polysaccharides (Swelling in Demineralized Water)

50 g of YuraQ M having a particle size D_{90.3}=15 μm (Döhler) is added to demineralized water with gentle stirring and allowed to swell at 20° C. for 2 hours while stirring. 50 g of an anthocyanin extract from red radish (H95113 Cos Red Radish) with an anthocyanin content of 4.0 wt % is added and stirred until a homogeneous doughy mass is obtained (approx. 1 hour). The mass is then filtered to separate excess liquid. Then, the mass is dried in an air stream, while the product temperature does not exceed 65° C. Finally, the dried product is ground again to D_{90.3}=100 μm. The yield is 98 wt % based on the total of the masses of YuraQ M and the anthocyanin extract.

The color value of the powder is measured in a color measuring device “Digieye” (Verivide Limited, Leicester, UK) under diffuse lighting and a color temperature of 5000 K and gives the following L*a*b* and C, H values:

| L | a | b | C | H |
|---|---|---|---|---|
| 21.78 | 33.24 | 7.13 | 34 | 12.11 |

### Examples 3 Through 15: Encapsulation of Various Natural Dyes in Tagua Nut Polysaccharides (Swelling in Saline Solution)

Similar to Example 1, further soluble dyes or color emulsions were encapsulated in tagua nut polysaccharides. In all examples, tagua nut polysaccharides “YuraQ” from Döhler GmbH were used, which had a particle size D_{90.3} of 15 μm. In order to demonstrate the broad applicability of the products obtained, these products were ground or sieved after coloring to obtain two powders with two different D_{90.3} particle sizes. In this way, two different color shades were obtained: A powder with a particle size D_{90.3} of 15 μm has a pastel shade, while a powder with a particle size D_{90.3} of approximately equal to or less than 100 μm has a slightly more intense color (see Table 1 and FIG. 2). A smaller pigment particle size generally increases the lightness (L) and saturation (C) of the color. C(=chroma) stands for the colorfulness. The higher the C value, the higher the colorfulness of the pigment.

The dyes listed below were examined. The serial number given in the table corresponds to the product number used by Döhler GmbH. Where two Döhler article numbers are given below, they refer to the same article which has assigned thereto documentation under a respective article number depending on the intended use. For example, the same composition may have assigned one article number for the “food” and one for the “cosmetic” sectors.

“Spirulina” This term refers to a composition of Döhler article number 215048 consisting of 55 wt % of Spirulina platensis extract, 40 wt % of trehalose, and 5 wt % of sodium citrate.

“Black diamond” This term refers to a composition of Döhler article numbers 954431 and 920154, respectively, consisting of glycerol (E422), a dye concentrate from Spirulina, barley malt extract (barley malt, water), a dye concentrate from beetroot, water, the acidifier citric acid (E330), and the antioxidant ascorbic acid (E300). It is a clear, black liquid with the following properties: 65.0 plus/minus 3 degrees Brix measured refractometrically at 20° C., pH 41 plus/minus 0.9, density 1.273 plus/minus 0.005 determined gravimetrically at 20° C. using a U-tube oscillator, and an acidity (calculated as CAA, pH=8.1) of 0.25 plus/minus 0.25 g per 100 g determined by titrimetry.

“Yellow Carrot” This term refers to a composition of Döhler article numbers 995097 and 794530, respectively, consisting of 48.4 to 52.4 wt % of maltodextrin, 42.6 to 46.6 wt % of Daucus carota sativa root extract, 3 to 4 wt % of caprylic/capric acid glycerides, and 1 to 2 wt % of citric acid, with the proportions of the substances mentioned adding up to 100 wt %.

“Orange Carrot” This term refers to a composition of Döhler article numbers 995095 and 794531, respectively, consisting of 37 to 42 wt % of maltodextrin, and 58 to 63 wt % of Daucus carota sativa root extract, with the proportions of the substances mentioned adding up to 100 wt %.

“Malt” This term is an abbreviation for “Cos Malt Extract Powder” and refers to malt extract (Hordeum vulgare) with CAS number 8002-48-0.

“Madder Root” This term refers to the product “NIG Dyestuff 11-MAD-COLOR” with CAS number 84650-16-8.

“Cos Natural Red” This term is an abbreviation for “Cos Natural Beta Carotene Red (Blakeslea trispora) Liq.” This is a composition with Döhler article numbers 995212 and 970810, respectively, consisting of 4 to 5.5 wt % of beta-carotene from Blakeslea trispora, 40 to 45 wt % of glycerol, 37 to 43 wt % of water, 8.5 to 11.5 wt % of gum arabic (Acacia Senegal gum), 0.7 to 1.1 wt % of ascorbic acid, 0.3 to 0.9 wt % of citric acid, and 0.09 to 0.2 wt % of tocopherol, with the proportions of the substances mentioned adding up to 100 wt %.

“Beet Root” This term refers to a composition with Döhler article numbers 968741 and 881004, respectively, consisting of 48.5 to 53.5 wt % of maltodextrin, 45.5 to 50.5 wt % of beetroot red (E162), 0.3 to 0.5 wt % of citric acid, and 0.05 to 0.15 wt % of ascorbic acid, with the proportions of the substances mentioned adding up to 100 wt %.

Red Radish” This term refers to a composition with Döhler article number 995113 consisting of 47.2 to 52.2 wt % of maltodextrin, 46.3 to 51.3 wt % of Raphanus sativus root extract, and 1.3 to 1.7 wt % of citric acid, with the proportions of the above-mentioned substances adding up to 100 wt %.

TABLE 1

| | | | | | | | YuraQ | | | |
|---|---|---|---|---|---|---|---|---|---|---|
| | | | | | | | (Tagua nut | | | Color value or |
| | Product; | | | | | | poly- | | | color content of |
| | Particle size D_{90.3} | | | | | | saccharide) | Dye | | starting |
| Ex. | of the product | L | a | b | C | H | [g] | [g] | NaCl | dye [wt %] |
| 3 | Spirulina 215048 | 28.86 | −8.07 | −18.66 | 20.33 | 246.6 | 50 | 50 | 20 g in 100 | 17.5-19.5 CU |
| | with YuraQ; 100 | | | | | | | | ml | |
| | μm | | | | | | | | | |
| 4 | Spirulina 215048 | 45.59 | −17.15 | −24.71 | 30.08 | 235.24 | 50 | 50 | 20 g in 100 | 17.5-19.5 CU |
| | with YuraQ; 15 μm | | | | | | | | ml | |
| 5 | Black diamond | 45.15 | −0.24 | 7.31 | 7.31 | 91.88 | 50 | 50 | 20 g in 100 | 3.5-5.5 CU |
| | 920154 with YuraQ; | | | | | | | | ml | |
| | 15 μm | | | | | | | | | |
| 6 | Black diamond | 28.03 | 0.49 | 2.24 | 2.29 | 77.69 | 50 | 50 | 20 g in 100 | 3.5-5.5 CU |
| | 920154 with YuraQ; | | | | | | | | ml | |
| | 100 μm | | | | | | | | | |
| 7 | Yellow Carrot | 78.18 | 11.45 | 41.39 | 42.95 | 74.53 | 50 | 50 | 20 g in 100 | 0.05-0.08% of |
| | 794530 with YuraQ; | | | | | | | | ml | total carotenoids |
| | 15 μm | | | | | | | | | |
| 8 | Yellow Carrot | 69.33 | 25.2 | 58.97 | 64.13 | 66.86 | 50 | 50 | 20 g in 100 | 0.05-0.08% of |
| | 794530 with YuraQ; | | | | | | | | ml | total carotenoids |
| | 100 μm | | | | | | | | | |
| 9 | Malt 87006 with | 50.15 | 9.59 | 22.38 | 24.35 | 66.8 | 50 | 50 | 20 g in 100 | 33 800-40 000 |
| | YuraQ; 15 μm | | | | | | | | ml | EBC |
| 10 | Orange Carrot | 77.31 | 18.3 | 30.04 | 35.18 | 58.66 | 50 | 50 | 20 g in 100 | 0.07-0.10% of |
| | 794531 with YuraQ; | | | | | | | | ml | total carotenoids |
| | 15 μm | | | | | | | | | |
| 11 | Orange Carrot | 71.93 | 24.19 | 35.65 | 43.08 | 55.84 | 50 | 50 | 20 g in 100 | 0.07-0.10% of |
| | 794531 with YuraQ; | | | | | | | | ml | total carotenoids |
| | 100 μm | | | | | | | | | |
| 12 | Malt 87006 with | 32.19 | 9.32 | 13.59 | 16.47 | 55.57 | 50 | 50 | 20 g in 100 | 33 800-40 000 |
| | YuraQ; 100 μm | | | | | | | | ml | EBC |
| 13 | Madder Root with | 31.89 | 22.78 | 25.68 | 34.32 | 48.45 | 50 | 50 | 20 g in 100 | Extract with dye |
| | YuraQ; 100 μm | | | | | | | | ml | content of |
| | | | | | | | | | | approx. 10% |
| 14 | Cos Natural Red | 61.1 | 32.35 | 31.2 | 44.94 | 43.96 | 50 | 50 | 20 g in 100 | 4.6-5.2% of total |
| | 970810 with YuraQ; | | | | | | | | ml | carotenoids as |
| | 15 μm | | | | | | | | | β-Carotene |
| 15 | Beetroot 881004 | 51.15 | 40.82 | 1.44 | 40.85 | 2.02 | 50 | 50 | 20 g in 100 | Dye content: |
| | with YuraQ; 15 μm | | | | | | | | ml | 0.36-0.45% of |
| | | | | | | | | | | betanin |

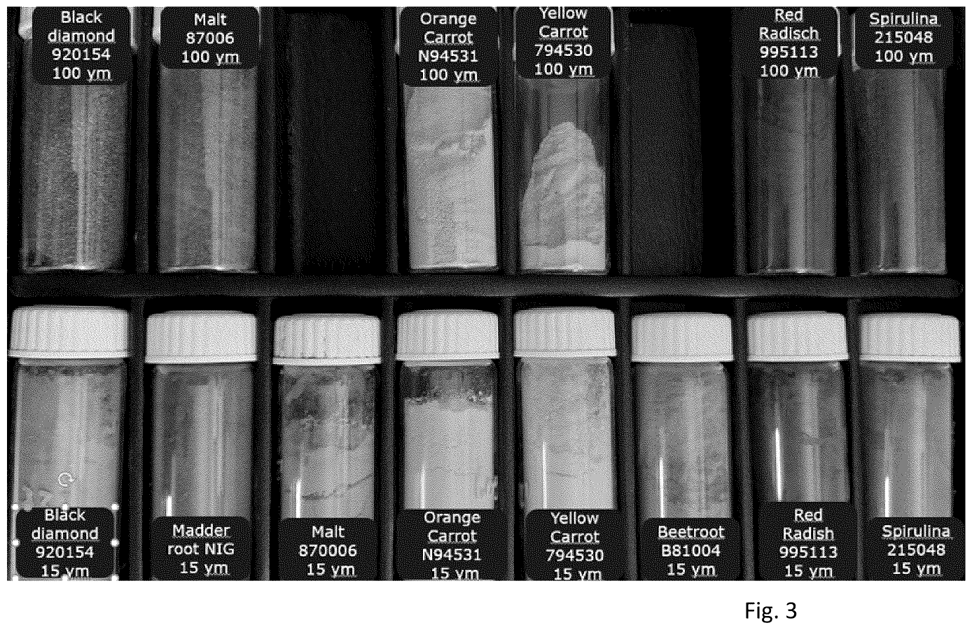

FIG. 3 shows photographs of the powdered samples of the colorants 1 from the examples. The upper row shows the samples with a particle size distribution of D_{90.3}=100 micrometers, the lower row shows those with D_{90.3}=15 micrometers.

The samples from examples 5 (bottom) and 6 (top) including the dye “Black Diamond” are shown on the far left. The second samples from the left are the samples from example 12 (top) including the dye “Malt” with a particle size distribution of D_{90.3}=100 micrometers, and below with the dye “Madder Root” with a particle size distribution of D_{90.3}=15 micrometers. To the right of the sample of the colorant including the dye “Madder Root”, a sample including the dye “Malt” with a particle size distribution of D_{90.3}=15 micrometers is shown according to example 9. The sample including the dye “Madder Root” was not ground in the tests. Generally, the same trend was found for all dyes tested: the larger the particle, the more intense the color shade.

In the middle of the figure, samples from examples 11 (top) and 10 (bottom) including the dye “Orange Carrot” are shown, to the left of samples from examples 8 (top) and 7 (bottom) with the dye “Yellow Carrot”.

On the far right, the samples from examples 4 (bottom) and 3 (top) with the dye “Spirulina” are shown. The second samples from the right are samples of the dye “Red Radish” with a particle size distribution of D_{90.3}=100 micrometers and of D_{90.3}=15 micrometers. This sample corresponds to the result of Example 1, the sample with D_{90.3}=100 micrometers is used for visual comparison. To the left of the samples with the colorant including the dye “Red Radish”, a sample of the dye “Beetroot” is shown with a particle size distribution of D_{90.3}=15 micrometers according to Example 15.

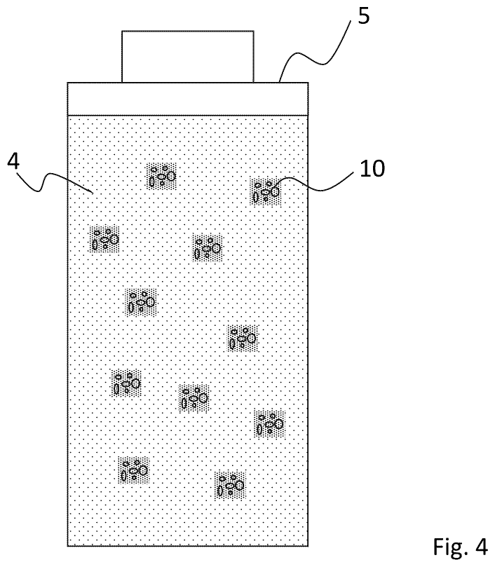

FIG. 4 schematically shows a colored product 4. This could be a beverage, for example. All other possible applications of a colored product are also conceivable, such as paints and lacquers in general, cosmetics, pharmaceuticals, dietary supplements, foodstuffs, and so on. The product 4 is filled in a container 5 and includes the colorant 1 in the form of dispersed pigments 10 of the colorant. For the sake of simplicity, the pigments are all shown to be of the same size, although it will be appreciated that the pigments of the colorant have a particle size distribution that can be determined as described above.

It will be appreciated by a person skilled in the art that the invention is not limited to the examples described above, but can rather be varied in various ways. In particular, the features of the individually presented examples can also be combined with one another or swapped for one another.

### LIST OF REFERENCE NUMERALS

1 Colorant
10 Pigment
2 Polysaccharide; polysaccharide including at least one beta-1,4-mannan; polysaccharide consisting essentially of beta-1,4-mannans; polysaccharide obtained from the endosperm of the tagua nut fruit
3 Dye
4 Product
5 Container
6 Water, aqueous saline solution
7 Mixture obtained in step (b)
8 Mass obtained in step (c)
9 Liquid
100 Solid phase obtained in step (d)
110 Dried solid phase obtained in step (d1)
111 Comminuted dried solid phase obtained in step (e); powder

1.-15. (canceled)

16. A colorant (1), comprising:
at least one pigment (10),
wherein the at least one pigment (10) includes
at least one polysaccharide (2) that is water-swellable, hydrophilic and water-insoluble; and
at least one dye (3).

17. The colorant (1) of claim 16,
wherein the at least one polysaccharide (2) includes at least one beta-1,4-mannan and preferably consists essentially of beta-1,4-mannans.

18. The colorant (1) of claim 17,
wherein the at least one polysaccharide (2) consists essentially of beta-1,4-mannans obtained from the endosperm of a tagua nut fruit.

19. The colorant (1) of claim 16,
wherein the at least one dye (3) is selected from the group consisting of natural dyes, synthetic dyes, and mixtures thereof,
wherein the natural dyes, synthetic dyes, and mixtures thereof are soluble in water or in other solvents.

20. The colorant (1) of claim 16,
wherein the colorant (1) is a powder (111).

21. The colorant (1) of claim 20,
wherein a particle size D90.3 of the powder (111) is between 0.5 μm and 120 μm.

22. An insoluble product (4), comprising:
at least one beta-1,4-mannan; and
at least one soluble substance (3) selected from the group consisting of dyes, flavorings, pharmaceutical active ingredients, antioxidants, cosmetic active ingredients, dietary supplements, and mixtures thereof.

23. The insoluble product (4) of claim 22, wherein the at least one beta-1,4-mannan is obtained from an endosperm of a tagua nut.

24. The colorant (1) of claim 16,
wherein the colorant (1) is provided in hydrophobicized form.

25. The insoluble product (4) of claim 22,
wherein the insoluble product (4) is provided in hydrophobicized form.

26. A method for producing a colorant (1) which comprises at least one pigment, or for producing an insoluble product (4), the method comprising:
(a) providing a powder that includes at least one polysaccharide (2) that is water-swellable, hydrophilic and water-insoluble;
(b) allowing the powder to swell in an aqueous solution to obtain a mixture (7);
(c) bringing the mixture (7) into contact with at least one substance selected from the group consisting of dyes (3), flavorings, pharmaceutical active ingredients, antioxidants, cosmetic active ingredients, dietary supplements, and mixtures thereof, to obtain a mass (8);
(d) separating excess liquid (9) from the mass (8) to obtain a solid phase (100).

27. The method of claim 26,
wherein the at least one polysaccharide (2) includes at least one beta-1,4-mannan.

28. The method of claim 27,
wherein the at least on polysaccharide consists essentially of beta-1,4-mannans and was obtained from an endosperm of a tagua nut fruit.

29. The method of claim 26,
wherein the polysaccharide (2) is provided as a powder having a particle size D90.3 between 0.5 μm and 120 μm.

30. The method of claim 26,
wherein the aqueous solution includes a salt which is appropriate for foodstuff, cosmetic and/or pharmaceutical products,
wherein the salt is selected from the group consisting of alkali or alkaline earth chlorides and mixtures thereof.

31. The method of claim 26, further comprising:
(d1) drying the solid phase (110) obtained in step (d).

32. The method of claim 26, further comprising:
(e) comminuting the solid phase (110) from step (d) to obtain a powder (111) having a particle size D90.3 from 0.5 μm to 120 μm.

33. The method of claim 32, further comprising:
(f) introducing
the mass (8) as obtained in step (c); and/or
the solid phase (100) as separated in step (d); and/or
the solid phase (110) dried in step (d1); and/or
the powder (111) comminuted in step (e)
into a product (4) selected from the group consisting of wall paints, artist paints, craftsman's paints and lacquers, foodstuff, luxury food, dietary supplements, cosmetic, and pharmaceutical products.

24. The method of claim 26,
wherein the dyes (3) are natural dyes and/or a synthetic dyes which are soluble in water or other solvents, or
wherein step (c) comprises introducing a soluble substance selected from the group consisting of flavorings, pharmaceutical active ingredients, antioxidants, cosmetic active ingredients, dietary supplements, and mixtures thereof.
